(19) United States
(12) Patent Application Publication
(10) Pub. No.: US 2024/0035255 A1
(43) Pub. Date: Feb. 1, 2024

(54) VALVE UNIT AND VALVE EQUIPMENT

(71) Applicant: KAWASAKI JUKOGYO KABUSHIKI KAISHA, Kobe-shi, Hyogo (JP)

(72) Inventors: Seiji AOKI, Kobe-shi (JP); Yoshiyuki TODE, Kobe-shi (JP); Masahiro OHIRA, Kobe-shi (JP)

(73) Assignee: KAWASAKI JUKOGYO KABUSHIKI KAISHA, Kobe-shi, Hyogo (JP)

(21) Appl. No.: 18/039,792

(22) PCT Filed: Dec. 13, 2021
(86) PCT No.: PCT/JP2021/045759

§ 371 Date: Jun. 1, 2023

(30) Foreign Application Priority Data
Dec. 18, 2020 (JP) 2020-209981

(51) Int. Cl. E02F 9/22

(52) U.S. Cl. CPC E02F 9/2267; E02F 9/2225

(57) ABSTRACT

A valve unit according to one embodiment includes valve equipment and control circuitry. The valve equipment includes a spool valve and a poppet-type logic valve. The spool valve switches a direction of supply and discharge of hydraulic oil to and from a hydraulic actuator. The logic valve is located between the spool valve and a hydraulic pump. The control circuitry controls the spool valve and the logic valve, such that if a supply flow rate of the hydraulic oil to the hydraulic actuator is less than a predetermined value, an opening area of a meter-in passage of the spool valve is less than an opening area of the logic valve, whereas if the supply flow rate of the hydraulic oil to the hydraulic actuator is greater than the predetermined value, the opening area of the meter-in passage of the spool valve is greater than the opening area of the logic valve.

### TECHNICAL FIELD

The present disclosure relates to valve equipment for a hydraulic actuator that moves bi-directionally, and to a valve unit including the valve equipment.

### BACKGROUND ART

Conventionally, there has been a known hydraulic circuit that is capable of performing meter-in control and meter-out control independently of each other regardless of whether a bi-directional hydraulic actuator moves in one direction or the other direction. For example, Patent Literature 1 discloses a hydraulic circuit 100 as shown in FIG. 5.

Specifically, in the hydraulic circuit 100 shown in FIG. 5, a meter-out switching valve 130, which switches the direction of supply and discharge of hydraulic oil to and from a hydraulic actuator 140, is connected to a hydraulic pump 110 and a hydraulic tank 120 by a pump line 111 and a tank line 121, respectively, and also connected to the hydraulic actuator 140 by a pair of supply/discharge lines 141 and 142. Further, a meter-in valve 150 is located on the pump line 111.

The opening area of the meter-in valve 150 at the time of moving the hydraulic actuator in one direction or the other direction is set to be less than the opening area of the meter-in passage of the meter-out switching valve 130. Accordingly, meter-in control by the meter-in valve 150 and meter-out control by the meter-out switching valve 130 can be performed independently of each other.

### CITATION LIST

### Patent Literature

PTL 1. Japanese Laid-Open Patent Application Publication No. 2016-145592

### SUMMARY OF INVENTION

### Technical Problem

Patent Literature 1 does not describe what types of valves the meter-out switching valve 130 and the meter-in valve 150 are. However, the meter-out switching valve 130 is, generally speaking, a spool valve. On the other hand, regarding the meter-in valve 150, in light of controlling the meter-in flow rate, it is presumed that the meter-in valve 150 is a spool valve. The reason for this is that it is difficult to control a micro flow rate by a poppet valve.

However, in a case where both the meter-out switching valve 130 and the meter-in valve 150 are spool valves, if one piece of valve equipment incorporates therein both the meter-out switching valve 130 and the meter-in valve 150, it results in an increase in the size of the valve equipment. On the other hand, in a case where a poppet valve is used as the meter-in valve 150, although the valve equipment incorporating therein the meter-out switching valve 130 and the meter-in valve 150 can be reduced in size, it is difficult with such valve equipment to control the meter-in flow rate when the meter-in flow rate is a micro flow rate.

In view of the above, an object of the present disclosure is to provide a valve unit that makes it possible to reduce the size of valve equipment therein and that is capable of performing meter-in control even when the meter-in flow rate is a micro flow rate. Another object of the present disclosure is to provide the valve equipment included in the valve unit.

### Solution to Problem

In order to solve the above-described problems, a valve unit according to the present disclosure includes: valve equipment including a spool valve and a poppet-type logic valve, wherein the spool valve switches a direction of supply and discharge of hydraulic oil to and from a hydraulic actuator, and the logic valve is located between the spool valve and a hydraulic pump; and control circuitry that, in a case of moving the hydraulic actuator, controls the spool valve and the logic valve, such that if a supply flow rate of the hydraulic oil to the hydraulic actuator is less than a predetermined value, an opening area of a meter-in passage of the spool valve is less than an opening area of the logic valve, whereas if the supply flow rate of the hydraulic oil to the hydraulic actuator is greater than the predetermined value, the opening area of the meter-in passage of the spool valve is greater than the opening area of the logic valve.

According to the above configuration, in a case where the supply flow rate of the hydraulic oil to the hydraulic actuator is less than the predetermined value, meter-in control can be performed by the spool valve. Accordingly, meter-in control can be performed even when the meter-in flow rate is a micro flow rate. On the other hand, in a case where the supply flow rate of the hydraulic oil to the hydraulic actuator is greater than the predetermined value, meter-in control can be performed by the logic valve. In addition, in the case where the supply flow rate of the hydraulic oil to the hydraulic actuator is greater than the predetermined value, since meter-out control can be performed by the spool valve, the meter-in control by the logic valve and the meter-out control by the spool valve can be performed independently of each other. By using the logic valve and the spool valve in this manner, the valve equipment can be reduced in size compared to a case where a spool valve dedicated for meter-in control and a spool valve dedicated for meter-out control are used.

Valve equipment according to the present disclosure is valve equipment used in a hydraulic excavator. The valve equipment includes: a boom spool valve that switches a direction of supply and discharge of hydraulic oil to and from a boom cylinder; a poppet-type boom logic valve located between the boom spool valve and a hydraulic pump; an arm spool valve that switches a direction of supply and discharge of the hydraulic oil to and from an arm cylinder; and a poppet-type arm logic valve located between the arm spool valve and the hydraulic pump or between the arm spool valve and another hydraulic pump different from the hydraulic pump.

According to the above configuration, for each of the boom cylinder and the arm cylinder, when the supply flow rate of the hydraulic oil to the cylinder is low, meter-in control by the spool valve can be performed, whereas when the supply flow rate of the hydraulic oil to the cylinder is high, meter-in control by the logic valve and meter-out control by the spool valve can be performed independently of each other.

### Advantageous Effects of Invention

The present disclosure provides a valve unit that makes it possible to reduce the size of valve equipment therein and that is capable of performing meter-in control even when the meter-in flow rate is a micro flow rate.

### BRIEF DESCRIPTION OF DRAWINGS

FIG. 1 shows a schematic configuration of a valve unit according to one embodiment of the present disclosure.

FIG. 2 is a side view of a hydraulic excavator.

FIG. 3 is a block diagram showing electrical devices of the valve unit.

FIG. 4 is a graph showing a relationship of the opening area of a meter-in passage of a spool valve and the opening area of a logic valve to the operating amount of an operator.

FIG. 5 shows a conventional hydraulic circuit.

### DESCRIPTION OF EMBODIMENTS

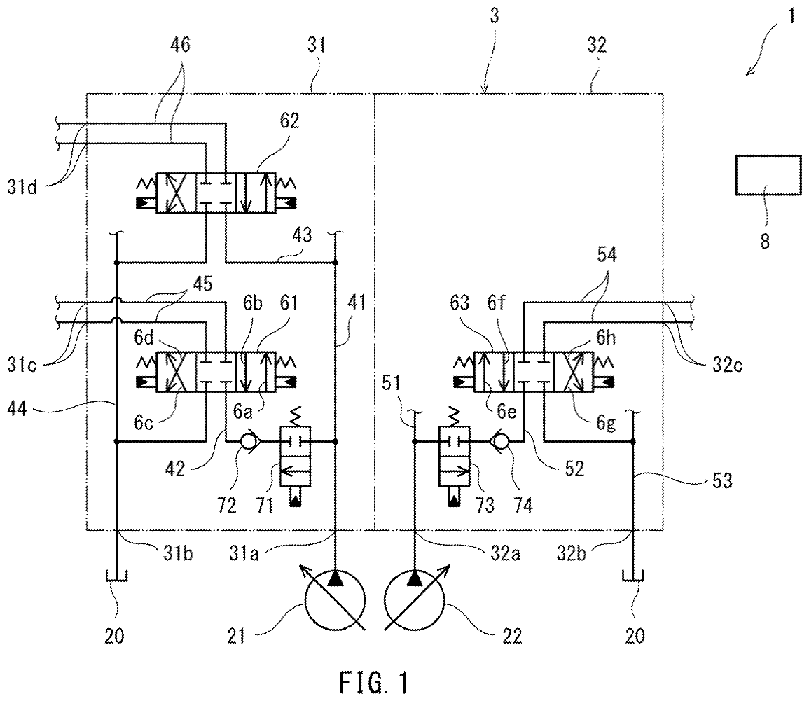

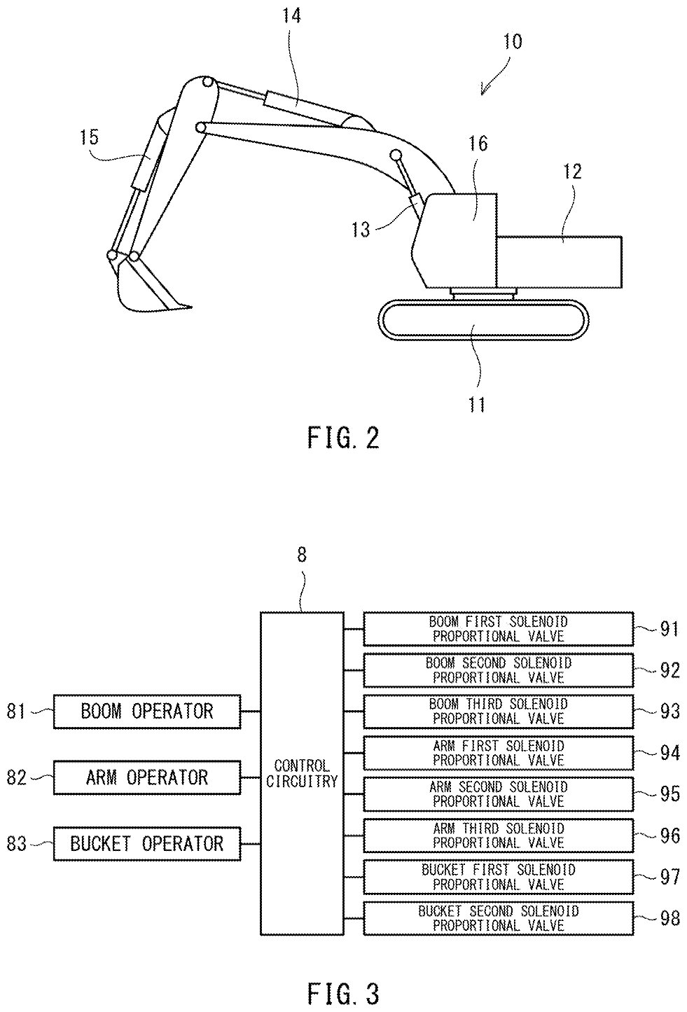

FIG. 1 shows a valve unit 1 according to one embodiment of the present disclosure. The valve unit 1 includes valve equipment 3 and control circuitry 8. The valve equipment 3 is incorporated in a hydraulic circuit. The control circuitry 8 controls devices included in the valve equipment 3. In the present embodiment, the valve unit 1 is used in a hydraulic excavator 10 shown in FIG. 2.

The hydraulic excavator 10 shown in FIG. 2 is a self-propelled hydraulic excavator, and includes a traveling structure 11. The hydraulic excavator 10 further includes a slewing structure 12 and a boom. The slewing structure 12 is slewably supported by the traveling structure 11. The boom is luffed relative to the slewing structure 12. An arm is swingably coupled to the distal end of the boom, and a bucket is swingably coupled to the distal end of the arm. The slewing structure 12 includes a cabin 16. The cabin 16 includes a driver's seat. The hydraulic excavator 10 need not be of a self-propelled type.

The hydraulic excavator 10 includes a boom cylinder 13, an arm cylinder 14, and a bucket cylinder 15 as bi-directional hydraulic actuators. The boom cylinder 13 luffs the boom. The arm cylinder 14 swings the arm. The bucket cylinder 15 swings the bucket. Although not illustrated, the hydraulic excavator 10 further includes a left travel motor, a right travel motor, and a slewing motor as bi-directional hydraulic actuators. The left travel motor drives the left crawler of the traveling structure 11. The right travel motor drives the right crawler of the traveling structure 11. The slewing motor slews the slewing structure 12.

In the present embodiment, two hydraulic pumps (a first hydraulic pump 21 and a second hydraulic pump 22) are installed in the hydraulic excavator 10. The first hydraulic pump 21 supplies hydraulic oil to the boom cylinder 13 and the bucket cylinder 15 via the valve equipment 3, and the second hydraulic pump 22 supplies the hydraulic oil to the arm cylinder 14 via the valve equipment 3. The description of the supply of the hydraulic oil to hydraulic actuators other than the boom cylinder 13, the arm cylinder 14, and the bucket cylinder 15 is omitted herein.

In the present embodiment, the valve equipment 3 includes a first block 31 and a second block 32. However, the valve equipment 3 need not include multiple blocks, but may include a single block.

The first block 31 includes a pump port 31a connected to the first hydraulic pump 21 and a tank port 31b connected to a hydraulic tank 20. The first block 31 further includes a pair of supply/discharge ports 31c connected to the boom cylinder 13 and a pair of supply/discharge ports 31d connected to the bucket cylinder 15.

Similarly, the second block 32 includes a pump port 32a connected to the second hydraulic pump 22 and a tank port 32b connected to the hydraulic tank 20. The second block 32 further includes a pair of supply/discharge ports 32c connected to the arm cylinder 14.

A boom spool valve 61 and a bucket spool valve 62 are incorporated in the first block 31, and an arm spool valve 63 is incorporated in the second block 32.

The first block 31 includes: a pump passage 41, which extends from the pump port 31a; a boom distribution passage 42, which connects the pump passage 41 to the boom spool valve 61; and a bucket distribution passage 43, which connects the pump passage 41 to the bucket spool valve 62. The first block 31 further includes a tank passage 44, which connects the boom spool valve 61 and the bucket spool valve 62 to the tank port 31b. The first block 31 further includes: a pair of supply/discharge passages 45, which connects the boom spool valve 61 to the pair of supply/discharge ports 31c; and a pair of supply/discharge passages 46, which connects the bucket spool valve 62 to the pair of supply/discharge ports 31d.

Similarly, the second block 32 includes: a pump passage 51, which extends from the pump port 32a; and an arm distribution passage 52, which connects the pump passage 51 to the arm spool valve 63. The second block 32 further includes a tank passage 53, which connects the arm spool valve 63 to the tank port 32b. The second block 32 further includes a pair of supply/discharge passages 54, which connects the arm spool valve 63 to the pair of supply/discharge ports 32c.

The boom spool valve 61 switches the supply direction of the hydraulic oil to the boom cylinder 13. The boom spool valve 61 includes a spool that shifts between a neutral position, a first acting position, and a second acting position. When the spool is at the neutral position, the spool blocks the boom distribution passage 42, the tank passage 44, and the pair of supply/discharge passages 45. When the spool is at the first acting position or the second action position, the spool allows one of the pair of supply/discharge passages 45 to communicate with the boom distribution passage 42, and allows the other one of the pair of supply/discharge passages 45 to communicate with the tank passage 44. Specifically, the boom spool valve 61 includes: a meter-in passage 6a and a meter-out passage 6b for the first acting position; and a meter-in passage 6c and a meter-out passage 6d for the second acting position.

Similarly, the arm spool valve 63 switches the supply direction of the hydraulic oil to the arm cylinder 14. The arm spool valve 63 includes a spool that shifts between a neutral position, a first acting position, and a second acting position. When the spool is at the neutral position, the spool blocks the arm distribution passage 52, the tank passage 53, and the pair of supply/discharge passages 54. When the spool is at the first acting position or the second acting position, the spool allows one of the pair of supply/discharge passages 54 to communicate with the arm distribution passage 52, and allows the other one of the pair of supply/discharge passages 54 to communicate with the tank passage 53. Specifically, the arm spool valve 63 includes: a meter-in passage 6e and a meter-out passage 6f for the first acting position; and a meter-in passage 6g and a meter-out passage 6h for the second acting position.

The bucket spool valve 62 switches the supply direction of the hydraulic oil to the bucket cylinder 15. The bucket spool valve 62 includes a spool that shifts between a neutral position, a first acting position, and a second acting position. When the spool is at the neutral position, the spool blocks the bucket distribution passage 43, the tank passage 44, and the pair of supply/discharge passages 46. When the spool is at the first acting position or the second acting position, the spool allows one of the pair of supply/discharge passages 46 to communicate with the bucket distribution passage 43, and allows the other one of the pair of supply/discharge passages 46 to communicate with the tank passage 44.

A poppet-type boom logic valve 71 is located on the boom distribution passage 42. Specifically, the boom logic valve 71 is located between the boom spool valve 61 and the first hydraulic pump 21. Further, a check valve 72, which allows a flow from the boom logic valve 71 toward the boom spool valve 61, but prevents the reverse flow, is located on the boom distribution passage 42 at a position downstream of the boom logic valve 71.

Similarly, a poppet-type arm logic valve 73 is located on the arm distribution passage 52. Specifically, the arm logic valve 73 is located between the arm spool valve 63 and the second hydraulic pump 22 different from the first hydraulic pump 21. Further, a check valve 74, which allows a flow from the arm logic valve 73 toward the arm spool valve 63, but prevents the reverse flow, is located on the arm distribution passage 52 at a position downstream of the arm logic valve 73.

As shown in FIG. 3, the valve unit 1 further includes: a boom operator 81 to move the boom cylinder 13; an arm operator 82 to move the arm cylinder 14; and a bucket operator 83 to move the bucket cylinder 15. These operators 81 to 83 are located in the cabin 16.

In the present embodiment, each of the boom operator 81, the arm operator 82, and the bucket operator 83 is an electrical joystick including an operating lever. The electrical joystick outputs, as an operation signal, an electrical signal corresponding to an operating amount (an inclination angle) of the operating lever. Accordingly, the operators 81 to 83 are electrically connected to the control circuitry 8. The electrical signal outputted from each of the boom operator 81, the arm operator 82, and the bucket operator 83 is inputted to the control circuitry 8.

Alternatively, each of the boom operator 81, the arm operator 82, and the bucket operator 83 may be a pilot operation valve that outputs, as an operation signal, a pilot pressure corresponding to an operating amount (an inclination angle) of the operating lever. In this case, the pilot pressure outputted from each pilot operation valve is detected by a pressure sensor, and inputted to the control circuitry 8.

For example, the control circuitry 8 is realized by a computer that includes memories such as a ROM and RAM, a storage such as a HDD or SSD, and a CPU. The CPU executes a program stored in the ROM or the storage.

The control circuitry 8 is electrically connected to boom first to third solenoid proportional valves 91 to 93, arm first to third solenoid proportional valves 94 to 96, and bucket first and second solenoid proportional valves 97 and 98. Although not illustrated in FIG. 1 for the purpose of simplifying the drawing, the boom first to third solenoid proportional valves 91 to 93 and the bucket first and second solenoid proportional valves 97 and 98 are mounted to the first block 31, and the arm first to third solenoid proportional valves 94 to 96 are mounted to the second block 32.

The above-described boom spool valve 61 includes: a first pilot port to shift the spool from the neutral position to the first acting position; and a second pilot port to shift the spool from the neutral position to the second acting position. The first and second pilot ports of the boom spool valve 61 are connected to the boom first and second solenoid proportional valves 91 and 92, respectively. That is, the control circuitry 8 controls the boom spool valve 61 via the boom first and second solenoid proportional valves 91 and 92.

Alternatively, the boom spool valve 61 may include not the first and second pilot ports but an electric actuator coupled to the spool, and the control circuitry 8 may directly control the boom spool valve 61.

In a case where the boom operator 81 is operated in a boom raising direction, the control circuitry 8 causes the boom first solenoid proportional valve 91 to output a secondary pressure such that the greater the operating amount of the boom operator 81, the higher the secondary pressure. Accordingly, the opening area of each of the meter-in passage 6a and the meter-out passage 6b of the boom spool valve 61 increases in accordance with increase in the operating amount of the boom operator 81. On the other hand, in a case where the boom operator 81 is operated in a boom lowering direction, the control circuitry 8 causes the boom second solenoid proportional valve 92 to outputs a secondary pressure such that the greater the operating amount of the boom operator 81, the higher the secondary pressure. Accordingly, the opening area of each of the meter-in passage 6c and the meter-out passage 6d of the boom spool valve 61 increases in accordance with increase in the operating amount of the boom operator 81.

The aforementioned boom logic valve 71 includes a poppet that shifts between a neutral position and an open position. When the poppet is at the neutral position, the poppet blocks the upstream-side portion of the boom distribution passage 42 from the downstream-side portion thereof, whereas when the poppet is at the open position, the poppet allows the upstream-side portion of the boom distribution passage 42 to communicate with the downstream-side portion thereof. The opening area of the boom logic valve 71 when the poppet is at the open position is arbitrarily adjustable.

In the present embodiment, the boom logic valve 71 includes a pilot port to shift the poppet from the neutral position to the open position. The pilot port of the boom logic valve 71 is connected to the boom third solenoid proportional valve 93. That is, the control circuitry 8 controls the boom logic valve 71 via the boom third solenoid proportional valve 93. The opening area of the boom logic valve 71 increases in accordance with increase in the secondary pressure outputted from the boom third solenoid proportional valve 93.

The boom logic valve 71 need not be a pilot-type valve, but may be a solenoid valve. In this case, the boom logic valve 71 is directly controlled by the control circuitry 8.

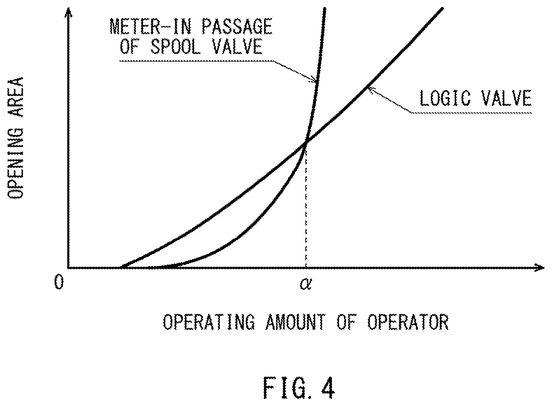

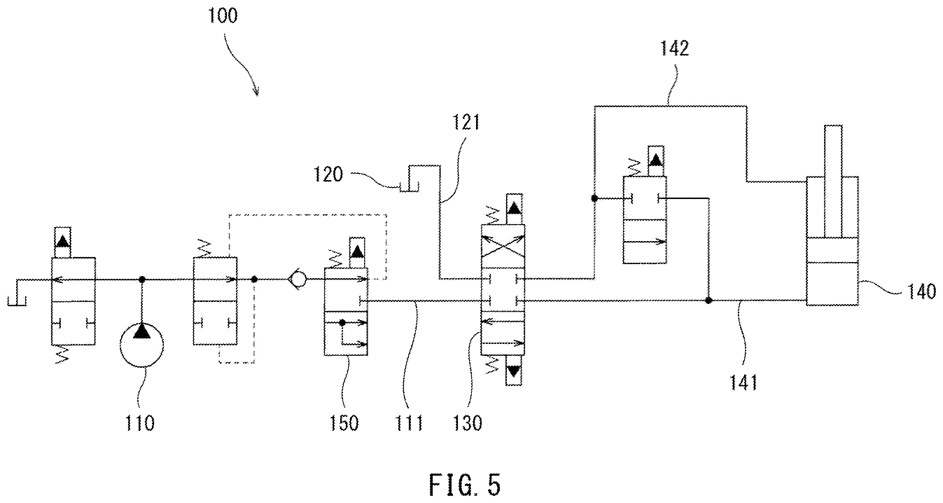

In the present embodiment, as shown in FIG. 4, in cases of moving the boom cylinder 13 (both at boom raising and at boom lowering), the control circuitry 8 controls the boom spool valve 61 and the boom logic valve 71, such that if the supply flow rate of the hydraulic oil to the boom cylinder 13 is less than a predetermined value Q1, the opening area of the meter-in passage (6a or 6c) of the boom spool valve 61 is less than the opening area of the boom logic valve 71, whereas if the supply flow rate of the hydraulic oil to the boom cylinder 13 is greater than the predetermined value Q1, the opening area of the meter-in passage (6a or 6c) of the boom spool valve 61 is greater than the opening area of the boom logic valve 71. For example, the predetermined value Q1 is set within the range of ⅙ to ⅓ of the maximum delivery flow rate of the first hydraulic pump 21.

In the present embodiment, based on the operating amount of the boom operator 81 (i.e., based on the electrical signal outputted from the boom operator 81), the control circuitry 8 determines whether the supply flow rate of the hydraulic oil to the boom cylinder 13 is less than or greater than the predetermined value Q1. Specifically, if the operating amount of the boom operator 81 is less than a predetermined value α, the control circuitry 8 determines that the supply flow rate of the hydraulic oil to the boom cylinder 13 is less than the predetermined value Q1, whereas if the operating amount of the boom operator 81 is greater than the predetermined value α, the control circuitry 8 determines that the supply flow rate of the hydraulic oil to the boom cylinder 13 is greater than the predetermined value Q1.

Further, in the present embodiment, in cases of moving the boom cylinder 13 (both at boom raising and at boom lowering), the control circuitry 8 controls the boom spool valve 61 and the boom logic valve 71, such that the boom logic valve 71 opens before the meter-in passage (6a or 6c) of the boom spool valve 61 opens.

The aforementioned arm spool valve 63 includes: a first pilot port to shift the spool from the neutral position to the first acting position; and a second pilot port to shift the spool from the neutral position to the second acting position. The first and second pilot ports of the arm spool valve 63 are connected to the arm first and second solenoid proportional valves 94 and 95, respectively. That is, the control circuitry 8 controls the arm spool valve 63 via the arm first and second solenoid proportional valves 94 and 95.

Alternatively, the arm spool valve 63 may include not the first and second pilot ports but an electric actuator coupled to the spool, and the control circuitry 8 may directly control the arm spool valve 63.

In a case where the arm operator 82 is operated in an arm crowding direction, the control circuitry 8 causes the arm first solenoid proportional valve 94 to output a secondary pressure such that the greater the operating amount of the arm operator 82, the higher the secondary pressure. Accordingly, the opening area of each of the meter-in passage 6e and the meter-out passage 6f of the arm spool valve 63 increases in accordance with increase in the operating amount of the arm operator 82. On the other hand, in a case where the arm operator 82 is operated in an arm pushing direction, the control circuitry 8 causes the arm second solenoid proportional valve 95 to output a secondary pressure such that the greater the operating amount of the arm operator 82, the higher the secondary pressure. Accordingly, the opening area of each of the meter-in passage 6g and the meter-out passage 6h of the arm spool valve 63 increases in accordance with increase in the operating amount of the arm operator 82.

The aforementioned arm logic valve 73 includes a poppet that shifts between a neutral position and an open position. When the poppet is at the neutral position, the poppet blocks the upstream-side portion of the arm distribution passage 52 from the downstream-side portion thereof, whereas when the poppet is at the open position, the poppet allows the upstream-side portion of the arm distribution passage 52 to communicate with the downstream-side portion thereof. The opening area of the arm logic valve 73 when the poppet is at the open position is arbitrarily adjustable.

In the present embodiment, the arm logic valve 73 includes a pilot port to shift the poppet from the neutral position to the open position. The pilot port of the arm logic valve 73 is connected to the arm third solenoid proportional valve 96. That is, the control circuitry 8 controls the arm logic valve 73 via the arm third solenoid proportional valve 96. The opening area of the arm logic valve 73 increases in accordance with increase in the secondary pressure outputted from the arm third solenoid proportional valve 96.

The arm logic valve 73 need not be a pilot-type valve, but may be a solenoid valve. In this case, the arm logic valve 73 is directly controlled by the control circuitry 8.

In the present embodiment, as shown in FIG. 4, in cases of moving the arm cylinder 14 (both at arm crowding and at arm pushing), the control circuitry 8 controls the arm spool valve 63 and the arm logic valve 73, such that if the supply flow rate of the hydraulic oil to the arm cylinder 14 is less than a predetermined value Q2, the opening area of the meter-in passage (6e or 6g) of the arm spool valve 63 is less than the opening area of the arm logic valve 73, whereas if the supply flow rate of the hydraulic oil to the arm cylinder 14 is greater than the predetermined value Q2, the opening area of the meter-in passage (6e or 6g) of the arm spool valve 63 is greater than the opening area of the arm logic valve 73. For example, the predetermined value Q2 is set within the range of ⅙ to ⅓ of the maximum delivery flow rate of the second hydraulic pump 22.

In the present embodiment, based on the operating amount of the arm operator 82 (i.e., based on the electrical signal outputted from the arm operator 82), the control circuitry 8 determines whether the supply flow rate of the hydraulic oil to the arm cylinder 14 is less than or greater than the predetermined value Q2. Specifically, if the operating amount of the arm operator 82 is less than a predetermined value α, the control circuitry 8 determines that the supply flow rate of the hydraulic oil to the arm cylinder 14 is less than the predetermined value Q2, whereas if the operating amount of the arm operator 82 is greater than the predetermined value α, the control circuitry 8 determines that the supply flow rate of the hydraulic oil to the arm cylinder 14 is greater than the predetermined value Q2.

Further, in the present embodiment, in cases of moving the arm cylinder 14 (both at arm crowding and at arm pushing), the control circuitry 8 controls the arm spool valve 63 and the arm logic valve 73, such that the arm logic valve 73 opens before the meter-in passage (6e or 6g) of the arm spool valve 63 opens.

As described above, in the valve unit 1 of the present embodiment, in a case where the supply flow rate of the hydraulic oil to the boom cylinder 13 is less than the predetermined value Q1, meter-in control can be performed by the boom spool valve 61. Accordingly, meter-in control can be performed even when the meter-in flow rate is a micro flow rate. On the other hand, in a case where the supply flow rate of the hydraulic oil to the boom cylinder 13 is greater than the predetermined value Q1, meter-in control can be performed by the boom logic valve 71. In addition, in the case where the supply flow rate of the hydraulic oil to the boom cylinder 13 is greater than the predetermined value Q1, since meter-out control can be performed by the boom spool valve 61, the meter-in control by the boom logic valve 71 and the meter-out control by the boom spool valve 61 can be performed independently of each other. By using the boom logic valve 71 and the boom spool valve 61 in this manner, the first block 31 of the valve equipment 3 can be reduced in size compared to a case where a spool valve dedicated for meter-in control and a spool valve dedicated for meter-out control are used.

Further, in the present embodiment, the boom logic valve 71 opens before the meter-in passage (6a or 6c) of the boom spool valve 61 opens. Accordingly, when the meter-in passage (6a or 6c) of the boom spool valve 61 opens, the hydraulic oil is supplied to the boom cylinder 13, and the boom cylinder 13 starts moving. Therefore, from when the boom cylinder 13 starts moving, meter-in control can be performed by the boom spool valve 61.

Similarly, in a case where the supply flow rate of the hydraulic oil to the arm cylinder 14 is less than the predetermined value Q2, meter-in control can be performed by the arm spool valve 63. Accordingly, meter-in control can be performed even when the meter-in flow rate is a micro flow rate. On the other hand, in a case where the supply flow rate of the hydraulic oil to the arm cylinder 14 is greater than the predetermined value Q2, meter-in control can be performed by the arm logic valve 73. In addition, in the case where the supply flow rate of the hydraulic oil to the arm cylinder 14 is greater than the predetermined value Q2, since meter-out control can be performed by the arm spool valve 63, the meter-in control by the arm logic valve 73 and the meter-out control by the arm spool valve 63 can be performed independently of each other. By using the arm logic valve 73 and the arm spool valve 63 in this manner, the second block 32 of the valve equipment 3 can be reduced in size compared to a case where a spool valve dedicated for meter-in control and a spool valve dedicated for meter-out control are used.

Further, in the present embodiment, the arm logic valve 73 opens before the meter-in passage (6e or 6g) of the arm spool valve 63 opens. Accordingly, when the meter-in passage (6e or 6g) of the arm spool valve 63 opens, the hydraulic oil is supplied to the arm cylinder 14, and the arm cylinder 14 starts moving. Therefore, from when the arm cylinder 14 starts moving, meter-in control can be performed by the arm spool valve 63.

(Variations)

The present disclosure is not limited to the above-described embodiment. Various modifications can be made without departing from the scope of the present disclosure.

For example, the valve unit of the present disclosure need not be used in a hydraulic excavator, but may be used in a different construction machine. Alternatively, the valve unit of the present disclosure may be used in various machines that are not construction machines.

The valve equipment 3 need not include multiple spool valves and multiple logic valves, but may include one spool valve and one logic valve.

The control circuitry 8 need not determine based on the operating amount of an operator whether the supply flow rate of the hydraulic oil to a hydraulic actuator is less than or greater than a predetermined value. For example, in a case where the hydraulic excavator 10 is an unmanned driven excavator, the control circuitry 8 may set an operation command based on an image captured by a camera, and based on the operation command, determine whether the supply flow rate of the hydraulic oil to the hydraulic actuator is less than or greater than the predetermined value.

The number of hydraulic pumps installed in the hydraulic excavator 10 may be one. In this case, the hydraulic oil is supplied from the one hydraulic pump to all the hydraulic actuators via the valve equipment 3. Further, in the case where only one hydraulic pump is installed in the hydraulic excavator 10, the boom logic valve 71 may be located between the hydraulic pump and the boom spool valve 61, and the arm logic valve 73 may be located between the hydraulic pump and the arm spool valve 63.

In a case where the valve equipment 3 includes the boom logic valve 71 and the arm logic valve 73, for each of the boom cylinder 13 and the arm cylinder 14, when the supply flow rate of the hydraulic oil to the cylinder is low, meter-in control by the spool valve can be performed, whereas when the supply flow rate of the hydraulic oil to the cylinder is high, meter-in control by the logic valve and meter-out control by the spool valve can be performed independently of each other. The logic valve can be used also for different control.

For example, in a case where the hydraulic oil is supplied from the second hydraulic pump 22 to the slewing motor via the valve equipment 3, the arm logic valve 73 may be used as a priority valve when an arm operation and a slewing operation are performed concurrently. The priority valve in this case serves to supply the hydraulic oil in a greater amount to either one of the arm cylinder 14 or the slewing motor, which is to be preferentially caused to operate.

### SUMMARY

In order to solve the above-described problems, a valve unit according to the present disclosure includes: valve equipment including a spool valve and a poppet-type logic valve, wherein the spool valve switches a direction of supply and discharge of hydraulic oil to and from a hydraulic actuator, and the logic valve is located between the spool valve and a hydraulic pump; and control circuitry that, in a case of moving the hydraulic actuator, controls the spool valve and the logic valve, such that if a supply flow rate of the hydraulic oil to the hydraulic actuator is less than a predetermined value, an opening area of a meter-in passage of the spool valve is less than an opening area of the logic valve, whereas if the supply flow rate of the hydraulic oil to the hydraulic actuator is greater than the predetermined value, the opening area of the meter-in passage of the spool valve is greater than the opening area of the logic valve.

According to the above configuration, in a case where the supply flow rate of the hydraulic oil to the hydraulic actuator is less than the predetermined value, meter-in control can be performed by the spool valve. Accordingly, meter-in control can be performed even when the meter-in flow rate is a micro flow rate. On the other hand, in a case where the supply flow rate of the hydraulic oil to the hydraulic actuator is greater than the predetermined value, meter-in control can be performed by the logic valve. In addition, in the case where the supply flow rate of the hydraulic oil to the hydraulic actuator is greater than the predetermined value, since meter-out control can be performed by the spool valve, the meter-in control by the logic valve and the meter-out control by the spool valve can be performed independently of each other. By using the logic valve and the spool valve in this manner, the valve equipment can be reduced in size compared to a case where a spool valve dedicated for meter-in control and a spool valve dedicated for meter-out control are used.

For example, based on an operating amount of an operator to move the hydraulic actuator, or based on an operation command set by the control circuitry, the control circuitry may determine whether the supply flow rate of the hydraulic oil to the hydraulic actuator is less than or greater than the predetermined value.

In the case of moving the hydraulic actuator, the control circuitry may control the spool valve and the logic valve, such that the logic valve opens before the meter-in passage of the spool valve opens. According to this configuration, when the meter-in passage of the spool valve opens, the hydraulic oil is supplied to the hydraulic actuator, and the hydraulic actuator starts moving. Therefore, from when the hydraulic actuator starts moving, meter-in control can be performed by the spool valve.

Valve equipment according to the present disclosure is valve equipment used in a hydraulic excavator. The valve equipment includes: a boom spool valve that switches a direction of supply and discharge of hydraulic oil to and from a boom cylinder; a poppet-type boom logic valve located between the boom spool valve and a hydraulic pump; an arm spool valve that switches a direction of supply and discharge of the hydraulic oil to and from an arm cylinder; and a poppet-type arm logic valve located between the arm spool valve and the hydraulic pump or between the arm spool valve and another hydraulic pump different from the hydraulic pump.

According to the above configuration, for each of the boom cylinder and the arm cylinder, when the supply flow rate of the hydraulic oil to the cylinder is low, meter-in control by the spool valve can be performed, whereas when the supply flow rate of the hydraulic oil to the cylinder is high, meter-in control by the logic valve and meter-out control by the spool valve can be performed independently of each other.

### REFERENCE SIGNS LIST

1 valve unit
10 hydraulic excavator
13 boom cylinder (hydraulic actuator)
14 arm cylinder (hydraulic actuator)
21, 22 hydraulic pump
3 valve equipment
61 boom spool valve
63 arm spool valve
6a, 6c, 6e, 6g meter-in passage
71 boom logic valve
73 arm logic valve
8 control circuitry
81 to 83 operator

1. A valve unit comprising:
valve equipment including a spool valve and a poppet-type logic valve, wherein the spool valve switches a direction of supply and discharge of hydraulic oil to and from a hydraulic actuator, and the logic valve is located between the spool valve and a hydraulic pump; and
control circuitry that, in a case of moving the hydraulic actuator, controls the spool valve and the logic valve, such that if a supply flow rate of the hydraulic oil to the hydraulic actuator is less than a predetermined value, an opening area of a meter-in passage of the spool valve is less than an opening area of the logic valve, whereas if the supply flow rate of the hydraulic oil to the hydraulic actuator is greater than the predetermined value, the opening area of the meter-in passage of the spool valve is greater than the opening area of the logic valve.

2. The valve unit according to claim 1, wherein
based on an operating amount of an operator to move the hydraulic actuator, or based on an operation command set by the control circuitry, the control circuitry determines whether the supply flow rate of the hydraulic oil to the hydraulic actuator is less than or greater than the predetermined value.

3. The valve unit according to claim 1, wherein
in the case of moving the hydraulic actuator, the control circuitry controls the spool valve and the logic valve, such that the logic valve opens before the meter-in passage of the spool valve opens.

4. Valve equipment used in a hydraulic excavator, the valve equipment comprising:
a boom spool valve that switches a direction of supply and discharge of hydraulic oil to and from a boom cylinder;
a poppet-type boom logic valve located between the boom spool valve and a hydraulic pump;
an arm spool valve that switches a direction of supply and discharge of the hydraulic oil to and from an arm cylinder; and
a poppet-type arm logic valve located between the arm spool valve and the hydraulic pump or between the arm spool valve and another hydraulic pump different from the hydraulic pump.

5. The valve unit according to claim 2, wherein
in the case of moving the hydraulic actuator, the control circuitry controls the spool valve and the logic valve, such that the logic valve opens before the meter-in passage of the spool valve opens.
